(19) United States
(12) Patent Application Publication
(10) Pub. No.: US 2026/0001387 A1
(43) Pub. Date: Jan. 1, 2026

(54) Mobile Refrigerator Module

(71) Applicant: Steve Valenzuela, Ridgecrest, CA (US)

(72) Inventor: Steve Valenzuela, Ridgecrest, CA (US)

(21) Appl. No.: 18/755,952

(22) Filed: Jun. 27, 2024

(51) Int. Cl. B60H 1/32

(52) U.S. Cl. CPC B60H 1/3229; B60H 1/3226

(57) ABSTRACT

The mobile refrigerator module includes an insulated housing module includes a front bench space separate from the inside volume and a back door for loading access, and a front door for maintenance access into the front bench space. The disclosure also includes a trailer to carry the insulated housing module thereon and a hitch and a ball to hitch a plurality of insulated housing modules connected in parallel. The disclosure additionally includes an evaporator coil distribution across the ceiling and an air circulation fan adjacent thereto to blow across the evaporator coils on the ceiling and circulate a refrigerated air through the inside volume. The disclosure further includes a refrigerator unit disposed in the front bench space and a reserved space for an electric generator also in the front bench space and thermally insulated from the inside volume.

### SUMMARY OF THE INVENTION

The disclosure is a refrigerator system which includes an insulated housing module comprising a floor and a ceiling and an inside volume and a front bench space separate from the inside volume and a back door for loading access, and a front door for maintenance access into the front bench space. The disclosure also includes a trailer with two wheels comprising a width and a length configured to carry the insulated housing module thereon and a hitch and a ball configured to hitch a plurality of insulated housing modules connected in parallel. The disclosure additionally includes an evaporator coil distribution across the ceiling and an air circulation fan adjacent thereto configured to blow across the evaporator coils on the ceiling and circulate a refrigerated air through the inside volume. The disclosure further includes a refrigerator unit disposed in the front bench space and a reserved space for an electric generator also disposed in the front bench space and thermally insulated from the inside volume.

### BRIEF DESCRIPTION OF THE DRAWINGS

FIG. 1 is a front perspective view of the mobile refrigerator module in accordance with an embodiment of the present disclosure.

FIG. 2 is a back perspective view of the mobile refrigerator module in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

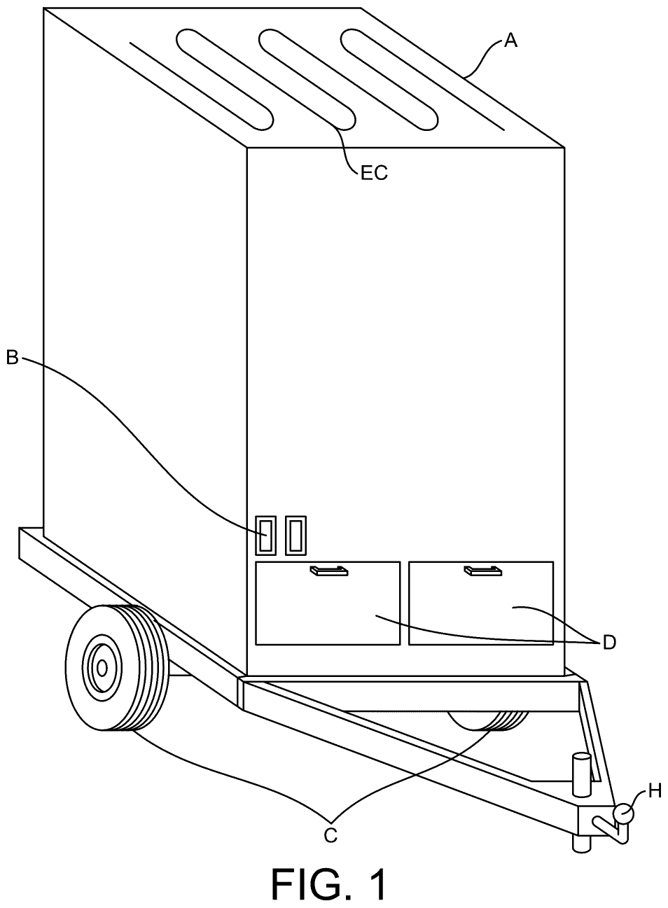

FIG. 1 is a front perspective view of the mobile refrigerator module showing the insulated housing module A, the power inlet and outlets B, the wheels C, the access doors D, the evaporator coils EC, the condensor coils E and the hitch H.

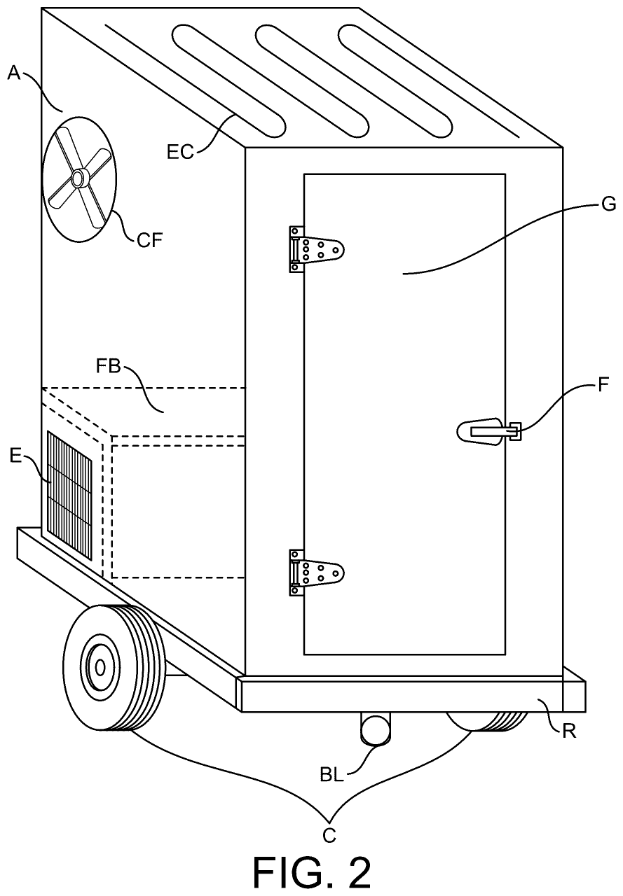

FIG. 2 is a back perspective view of the mobile refrigerator module in accordance with an embodiment of the present disclosure. The view includes the front bench FB in broken lines interior to the insulated housing module, the hitch ball BL, for parallel hookup with the hitch H of another trailer and another mobile refrigerator module, the circulating fan CF, the evaporator coils EC, the back door G, the back door latch F and the storing ramp R stored underneath the trailer.

Embodiments of the refrigerator module include a 77×98 inch flat bed trailer framed with steel studs and insulated with 3.75 inches of insulation similar to a turtle shell. All components are secured inside walls for security and weather advantage. The module is powered by 1 horse power 120 volt condensing unit and evaporator coil.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A refrigerator system
comprising: an insulated housing module comprising a floor and a ceiling and an inside volume and a front bench space separate from the inside volume and a back door for loading access, and a front door for maintenance access into the front bench space;
a trailer with two wheels comprising a width and a length configured to carry the insulated housing module thereon and a hitch and a ball configured to hitch a plurality of insulated housing modules connected in parallel;
an evaporator coil distribution across the ceiling and an air circulation fan adjacent thereto configured to blow across the evaporator coils on the ceiling and circulate a refrigerated air through the inside volume;
a refrigerator unit disposed in the front bench space and a reserved space for an electric generator also disposed in the front bench space and thermally insulated from the inside volume.

2. The refrigerator system of claim 1, further comprising an electric power inlet for an external generator and an electric power outlet for parallel trailer hookup.

3. The refrigerator system of claim 1, further comprising a plurality of portable shelves disposed in the inside volume configured to receive frozen goods.

4. The refrigerator system of claim 1, further comprising a plurality of free standing shelves disposed from the floor to the ceiling.

5. The refrigerator system of claim 1, further comprising a plurality of free standing shelves disposed from the front bench space to the ceiling.

6. The refrigerator system of claim 1, further comprising an electric generator disposed inside the front bench space configured to power the refrigerator.

7. The refrigerator system of claim 1, further comprising a storing ramp configured to enable a rolling access from ground through the back door.

8. The refrigerator system of claim 1, further comprising a locking latch for the back door.

9. The refrigerator system of claim 1, wherein the back door is insulated to an R value equivalent to an R value of the insulated housing module.

10. The refrigerator system of claim 1, wherein an insulation value for the insulated housing module is equivalent to 3.75 inches of dead air.

11. The refrigerator system of claim 1, further comprising a plurality of bumpers disposed on a plurality of walls of the insulated housing module.

12. The refrigerator system of claim 1, wherein the width and the length of the trailer are 77 inches by 98 inches.
